(19) United States
(12) Patent Application Publication
(10) Pub. No.: US 2013/0092202 A1
(43) Pub. Date: Apr. 18, 2013

(54) WALKING AID HAVING A SAFETY ASSEMBLY

(71) Applicant: CHING-TSANG WU, XINBEI CITY (TW)

(72) Inventor: CHING-TSANG WU, XINBEI CITY (TW)

(21) Appl. No.: 13/276,394

(22) Filed: Oct. 19, 2011

(30) Foreign Application Priority Data
Oct. 12, 2011 (TW) 100219120

(51) Int. Cl. A61H 3/04

(52) U.S. Cl. 135/67

(57) ABSTRACT

A walking aid has a safety assembly installed on a main frame for helping a brake assembly stop a rotation of a wheel set thereof. Namely, by means of a brake handle of the brake assembly being secured by the safety assembly, the wheel set is firmly fixed to prevent the walking aid from instability in case of any unintentional collision.

### FIELD OF THE INVENTION

The present invention relates to a walking aid, particularly to a walking aid having a safety assembly.

### DESCRIPTION OF THE RELATED ART

A walking aid is generally utilized by the handicapped or the elders. Referring to FIG. 1, a conventional walking aid 1 comprises a main frame 11, a wheel set 12 disposed at a bottom of the main frame 11, a pair of handle frames 13 symmetrically disposed on the main frame 11, a brake assembly 14 disposed on the handle frames 13, and a safety assembly 15 (shown by a sketch) for securing the brake assembly 14. Wherein, the brake assembly 14 has a brake handle 141, a braking member 142 (shown by a sketch) disposed on the main frame 11 for controlling a rotation of the wheel set 12, and a braking line 143 connected between the brake handle 141 and the braking member 142. In time of using, users hold the handle frames 13 for propelling the main frame 11 so as to concurrently rotate the wheel set 12. During the propelling, users could properly employ the brake assembly 14 on the handle frame 13 to decelerate. Moreover, when the brake handle 141 is fixed on the safety assembly 15, the braking member 142 preferably secures the wheel set 12. Accordingly, the walking aid 1 is mobile and convenient.

Herein, the brake handle 141 could be adjusted on the safety assembly 15 via different securing angles for properly securing the wheel set 12 with various securing states. However, if the brake handle 141 is accidentally contacted, it easily departs from the safety assembly 15 since there is no suitable securing means provided therebetween. As a result, when the braking member 142 could not efficiently arrest the rotation of the wheel set 12, the walking aid 1 is subject to slip, which is very inconvenient and dangerous for the handicapped or the elders.

### SUMMARY OF THE INVENTION

It is therefore the purpose of this invention to provide a walking aid having a safety assembly that ensures the walking aid with a proper fixing means when stops.

The walking aid having a safety assembly in accordance with the present invention comprises a main frame, a wheel set disposed at a bottom of the main frame, a pair of handle frames symmetrically disposed on the main frame, and at least one brake assembly installed on the handle frames. The brake assembly includes a brake handle, a braking member disposed on the main frame for controlling a motivation of the wheel set, and a braking line disposed between the brake handle and the braking member. Characterized in that, a receiving slot is defined on the brake handle and a safety assembly is disposed on one of the handle frames for securing the brake handle. The safety assembly has a controlling member disposed on the handle frame and a fixing member disposed corresponding to the receiving slot and motivated by the controlling member. A bulge is extended outwards from the fixing member. Driven by the controlling member and the fixing member, the bulge could be lodged in the receiving slot for allowing the handle brake as well as the braking member to firmly position the wheel set.

Preferably, each handle frame is assembled by an upper shaft and a lower shaft that are superimposed with each other; a plurality of limiting slots are equidistantly defined on the upper shaft, and an adjusting member is disposed on the lower shaft; the adjusting member includes a body disposed on the lower shaft with an opening defined thereon, an actuating member pivoted to the opening, and a spring disposed between the actuating member and the body; a positioning block is protruded on the actuating member, so that the positioning block subject to a move of the actuating member enters the opening and plugs one of the limiting slots for positioning.

Preferably, the brake assembly has an inner shaft that is disposed between the braking line and the braking member for connecting to the braking member, an engaging member having two ends respectively connected to the braking line and the inner shaft for motivating the inner shaft, a regulating member disposed on the engaging member for regulating the braking line, and an engaging seat that limits a moving scope of the engaging member; the braking line, the inner shaft, the engaging member, and the engaging seat are disposed in the handle frame; the regulating member is obtruded from the handle frame.

Preferably, the safety assembly further includes a restraining block disposed on the handle frame for restraining a moving scope of the controlling member.

Accordingly, when the wheel set is arrested by means of the safety assembly firmly positioning the brake handle, any accidental collision to the brake assembly would not result in a departure of the brake handle. Therefore, the positioning effect of the walking aid is ensured, and the using safety is increased.

### BRIEF DESCRIPTION OF THE DRAWINGS

FIG. 1 is a schematic view showing a conventional walking aid;

FIG. 2 is a schematic view showing a first preferred embodiment of the present invention;

FIGS. 3 and 4 are schematic view showing partial elements of FIG. 2;

FIG. 5 is a schematic view showing another partial elements of FIG. 2;

FIGS. 6 and 7 are schematic views showing a controlling member of the first preferred embodiment;

FIG. 8 is a schematic view showing a second preferred embodiment of the present invention; and

FIG. 9 is a schematic view showing partial elements of FIG. 8.

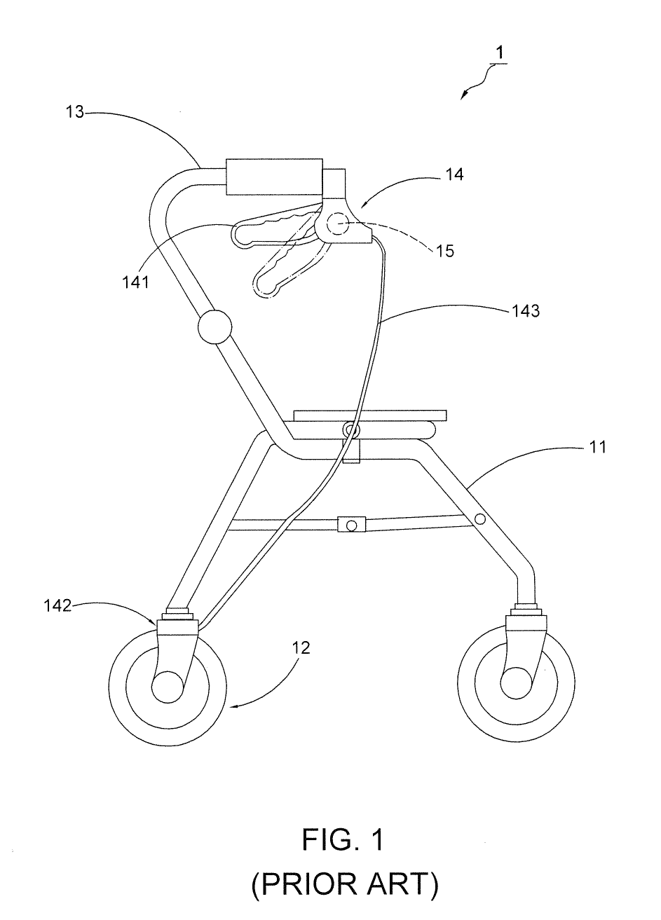

### DETAILED DESCRIPTION OF THE PREFERRED EMBODIMENTS

Wherever possible, the same reference numbers are used in the drawings and the description to refer to the same or like parts.

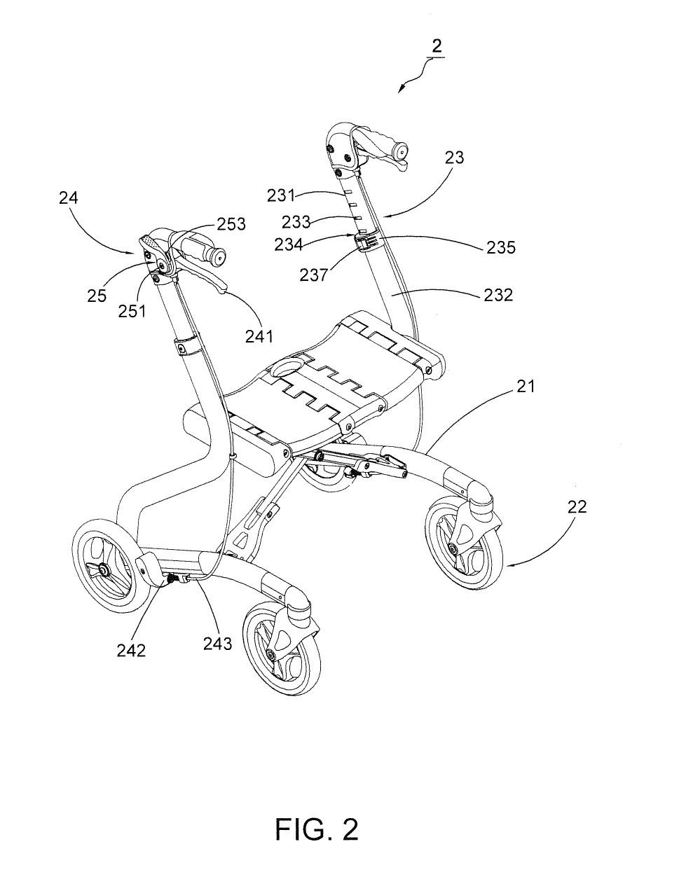

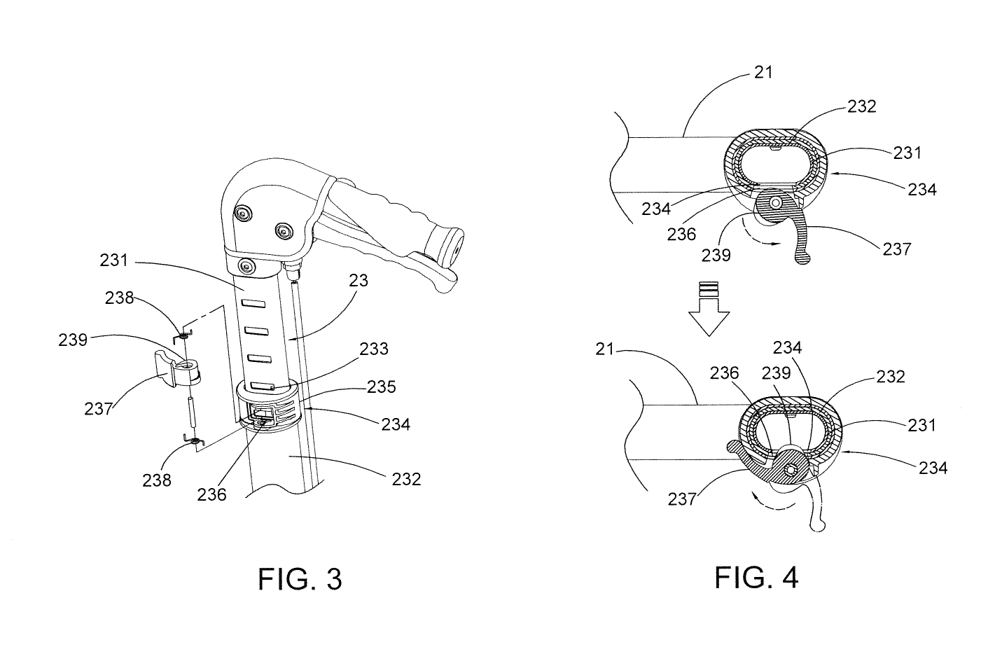

Referring to FIG. 2, a first preferred embodiment of the present invention is shown. A walking aid 2 having a safety assembly comprises a main frame 21, a wheel set 22 disposed at a bottom of the main frame 21, a pair of handle frames 23 symmetrically disposed on the main frame 21, and at least one brake assembly 24 disposed on the handle frame 23. Herein, accompanying with FIGS. 3 and 4, each handle frame 23 includes an upper shaft 231 and a lower shaft 232 superimposed with each other. A plurality of limiting slots 233 are equidistantly defined on the upper shaft 231, and an adjusting member 234 is disposed on the lower shaft 232. The adjusting member 234 includes a body 235 disposed on the lower shaft 232 with an opening 236 defined thereon, an actuating member 237 pivoted to the lower shaft 232, and a spring 238 disposed between the actuating member 237 and the body 235. A positioning block 239 is protruded on the actuating member 237. Moving the actuating member 237 concurrently motivates the positioning block 239, thereby allowing the positioning block 239 to protrude toward the opening 236 and plug one of the limiting slots 233 for positioning.

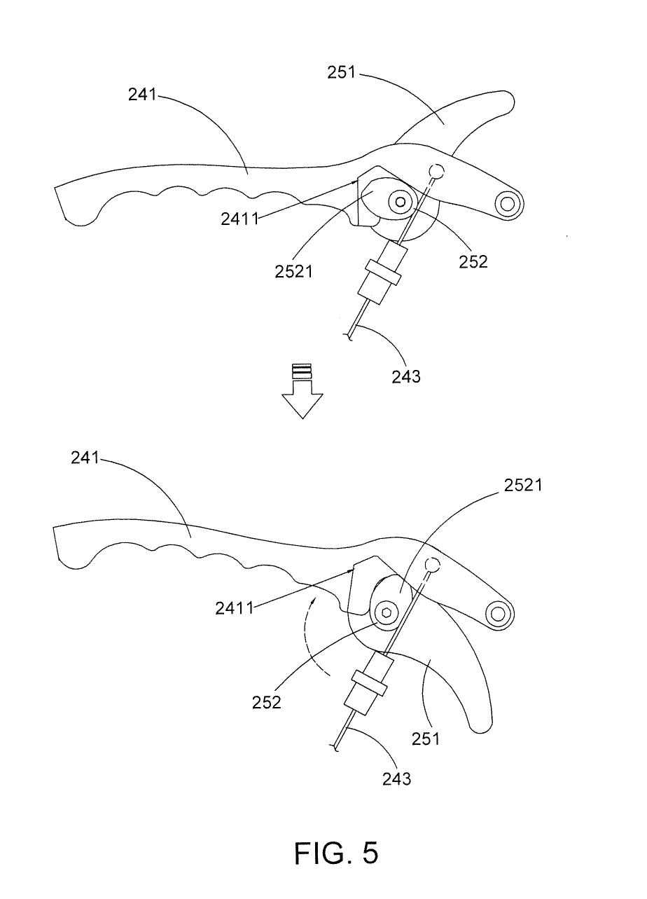

Further referring to FIG. 5, the brake assembly 24 includes a brake handle 241, a braking member 242 disposed on the main frame 21 for controlling a motivation of the wheel set 22, and a braking line 243 disposed between the brake handle 241 and the braking member 242. A receiving slot 2411 is defined on the brake handle 241.

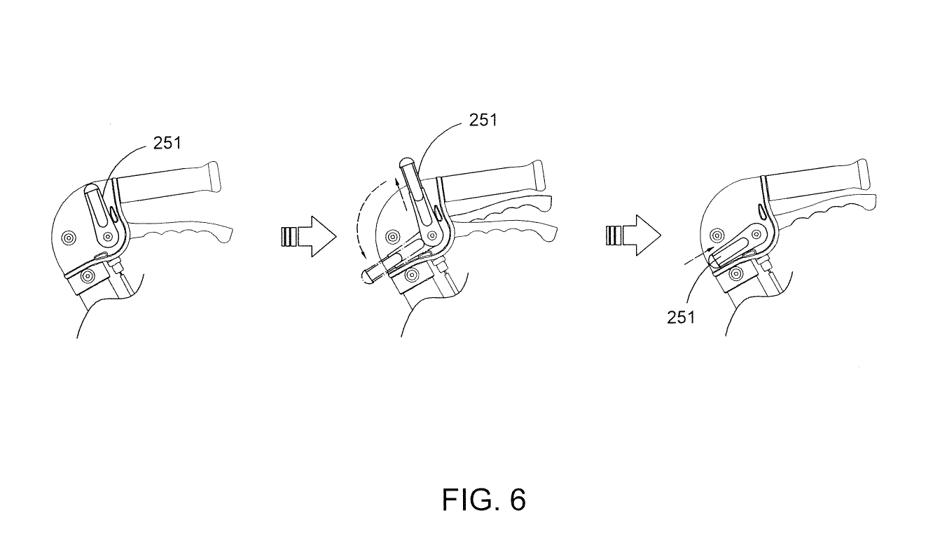

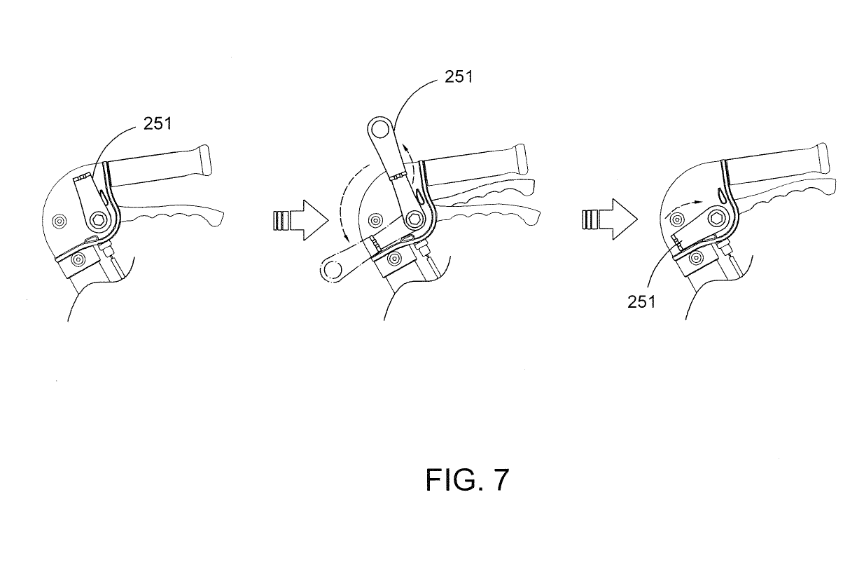

Especially, a safety assembly 25 is disposed on the handle frame 23 for controlling the brake handle 241. Wherein, the safety assembly 25 has a controlling member 251 disposed on the handle frame 23, a fixing member 252 disposed corresponding to the receiving slot 2411 and motivated by the controlling member 251, and a bulge 253 disposed on the handle frame 23 for limiting a moving scope of the controlling member 251. The controlling member 251 could freely adopt a pry, a telescopic design as shown in FIG. 6, or a collapsible design as shown in FIG. 7. A bulge 2521 is extended outwards from the fixing member 252. Driven by the controlling member 251 and the fixing member 252, the bulge 2521 could be lodged in the receiving slot 2411 for allowing the handle brake 241 as well as the braking member 242 to firmly position the wheel set 22.

Referring to FIGS. 3 and 4, in time of using, users previously adjust the actuating member 237, thereby departing the positioning block 239 from the opening 236 as well as anyone of the limiting slots 233. When an appropriate height of the handle frames 23 is decided, the upper shaft 231 and the lower shaft 232 will be fixed accordingly. Namely, once the opening 236 is set corresponding to any one of the limiting slots 233 on the upper shaft 231, the actuating member 237 is pushed toward the opening 236 as well as the limiting slot 233. In the meantime, the spring 238 provides a bouncing force, so that the positioning block 239 could be lodged in the limiting slot 233 by passing through the opening 236. As a result, the length of the upper shaft 231 is shortened, which allows the height of the handle frame 23 to be more suited to users. Referring to FIGS. 2 and 5, when users hold the handle frames 23 and propel the main frame 21, the wheel set 22 concurrently rotates. During the propelling, if the brake handle 241 is properly clutched, the braking line 243 as well as the braking member 242 would cooperatively decelerate the rotation of the wheel set 22. Finally, the wheel set 22 even stops. Herein, users may desire to hold the wheel set 22 and place the walking aid 2 in a particular spot. Whereby, the controlling member 251 on the handle frame 23 should be moved to synchronically drive the fixing member 252. Upon the controlling member 251 contacting any one of the restraining blocks 253 (two restraining blocks are shown), the motion of the controlling member 251 stops. Therefore, the bulge 2521 is wedged into the receiving slot 2411 via the controlling member 251 and the fixing member 252 so as to secure the brake handle 241. Consequently, the braking member 242 is driven to firmly secure the wheel set 22. Preferably, the controlling member 251 on the handle frame 23 appropriately locks the brake handle 241, preventing the walking aid 2 from moving even if an accidental force is brought to the brake handle 241.

In contrast, if the locked wheel set 22 is to be released, the controlling member 251 should be moved oppositely to contact the other restraining block 253. Whereby, the bulge 2521 is no longer wedged in the receiving slot 2411 by means of the fixing member 252. Accordingly, the brake handle 241 is unlocked and the wheel set 22 is not restrained by the braking member 242, which allows the walking aid 2 to freely move. Thus, by means of the safety assembly 25 being installed on the handle frame 23 to control the brake handle 241, the operation of the present invention is more convenient and safe since the brake handle 241 preferably provides the brake assembly 24 with a secure locking effect on the wheel set 22 so as to prevent any unintentional collision.

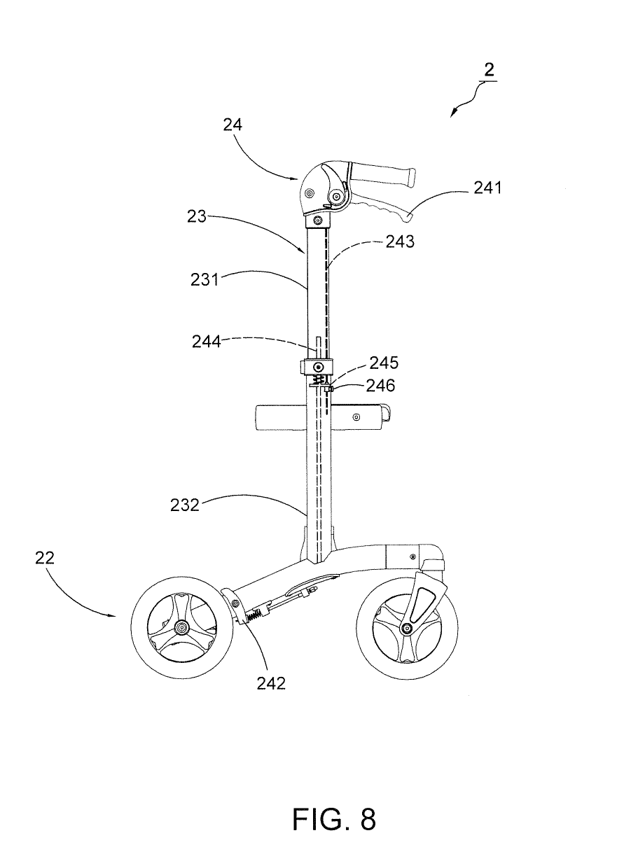

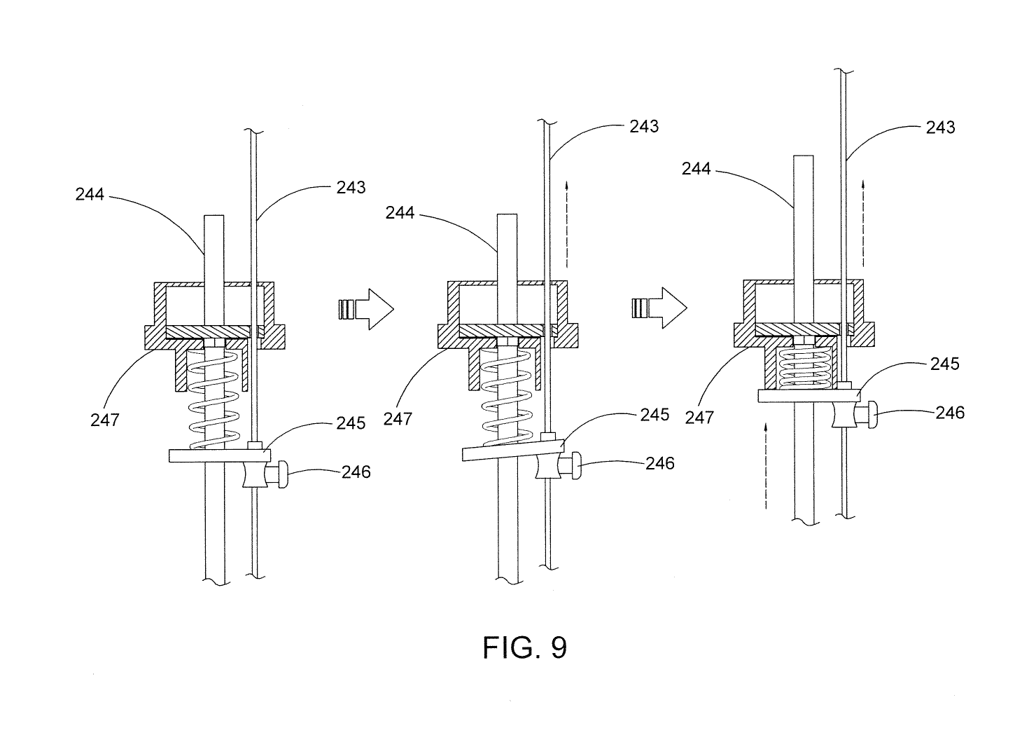

Referring to FIGS. 8 and 9, another preferred embodiment of the present invention is shown. In order to clearly show the features of the walking aid 2, these figures and the following depiction focus on another side of the walking aid 2. Besides afore elements and their correlations, the walking aid 2 of the present invention allows its brake assembly 24 to further include an inner shaft 244 connected between the braking line 243 and the braking member 242, an engaging member 245 whose two sides are respectively connected to the braking line 243 and the inner shaft 244, a regulating member 246 disposed on the engaging member 245 for regulating the braking line 243, and an engaging seat 247 that limits a moving scope of the engaging member 245. Moreover, the braking line 243, the inner shaft 244, the engaging member 245, and the engaging seat 247 are all arranged in the handle frame 23, which allows the handle frame 23 to provide a plain appearance. Further, since the regulating member 246 is protrudent on the handle frame 23, users can regulate the moving scope from the braking line 243 to the engaging member 245 via the regulating member 246 when the height of the upper shaft 231 and the lower shaft 232 are to be adjusted.

Therefore, when users utilize the brake handle 241 to slow down or stop the walking aid 2, the engaging member 245 is motivated by the braking line 243 so as to bring the inner shaft 244 upward. Once the engaging member 245 props against the engaging seat 247, the braking member 242 is hauled by the inner shaft 244 so as to press the wheel set 22 for decelerating or braking the walking aid 2. In fact, by means of the braking line 243, the inner shaft 244, the engaging member 245, and the engaging seat 247 being arranged in the handle frame 23, the walking aid 2 offers a clean and a succinct appearance. Favorably, the shielded braking line 243 does not entangle itself with other objects. Hence, users are ensured against danger in time of using and the using convenience is also assured.

To sum up, the present invention in particularly utilizes the safety assembly disposed on the handle frame to control the brake assembly. Thus, when the wheel set stops rotation by means of the brake assembly, the safety assembly properly secures the brake handle. Accordingly, the walking aid of the present invention is not easily influenced by any unintended contact since the brake assembly thereof could help the wheel set to be firmly fixed. Promoting the using safety and enhancing the stability as well as the operating convenience, the walking aid of the present invention is deemed novel and inventive.

While we have shown and described the embodiment in accordance with the present invention, it should be clear to those skilled in the art that further embodiments may be made without departing from the scope of the present invention.

I claim:

1. A walking aid having a safety assembly comprising a main frame, a wheel set disposed at a bottom of said main frame, a pair of handle frames symmetrically disposed on said main frame, and at least one brake assembly installed on said handle frames; said brake assembly including a brake handle, a braking member disposed on said main frame for controlling a motivation of said wheel set, and a braking line disposed between said brake handle and said braking member;
wherein, a receiving slot is defined on said brake handle and a safety assembly is disposed on one of said handle frames for securing said brake handle; said safety assembly having a controlling member disposed on said handle frame and a fixing member disposed corresponding to said receiving slot and motivated by said controlling member; a bulge being extended outwards from said fixing member; driven by said controlling member and said fixing member, said bulge could be lodged in said receiving slot for allowing said handle brake as well as said braking member to firmly position said wheel set.

2. The walking aid as claimed in claim 1, wherein, each handle frame is assembled by an upper shaft and a lower shaft that are superimposed with each other; a plurality of limiting slots are equidistantly defined on said upper shaft, and an adjusting member is disposed on said lower shaft; said adjusting member includes a body disposed on said lower shaft with an opening defined thereon, an actuating member pivoted to said opening, and a spring disposed between said actuating member and said body; a positioning block is protruded from said actuating member so that said positioning block subject to a move of said actuating member enters said opening and plugs one of said limiting slots for positioning.

3. The walking aid as claimed in claim 1, wherein, said brake assembly has an inner shaft that is disposed between said braking line and said braking member for connecting to said braking member, an engaging member having two ends respectively connected to said braking line and said inner shaft for motivating said inner shaft, a regulating member disposed on said engaging member for regulating said braking line, and an engaging seat that limits a moving scope of said engaging member; said braking line, said inner shaft, said engaging member, and said engaging seat are disposed in said handle frame; said regulating member is obtruded from said handle frame.

4. The walking aid as claimed in claim 2, wherein, said brake assembly has an inner shaft that is disposed between said braking line and said braking member for connecting to said braking member, an engaging member having two ends respectively connected to said braking line and said inner shaft for motivating said inner shaft, a regulating member disposed on said engaging member for regulating said braking line, and an engaging seat that limits a moving scope of said engaging member; said braking line, said inner shaft, said engaging member, and said engaging seat are disposed in said handle frame; said regulating member is obtruded from said handle frame.

5. The walking aid as claimed in claim 1, wherein, said safety assembly further includes a restraining block disposed on said handle frame for restraining a moving scope of said controlling member.

6. The walking aid as claimed in claim 2, wherein, said safety assembly further includes a restraining block disposed on said handle frame for restraining a moving scope of said controlling member.

7. The walking aid as claimed in claim 3, wherein, said safety assembly further includes a restraining block disposed on said handle frame for restraining a moving scope of said controlling member.

8. The walking aid as claimed in claim 4, wherein, said safety assembly further includes a restraining block disposed on said handle frame for restraining a moving scope of said controlling member.
